(19) United States
(12) Patent Application Publication
(10) Pub. No.: US 2018/0074687 A1
(43) Pub. Date: Mar. 15, 2018

(54) STEERING WHEEL HARD SWITCH FOR CONTROL OF MID SOFTWARE SWITCHES

(71) Applicant: Toyota Motor Engineering & Manufacturing North America, Inc., Erlanger, KY (US)

(72) Inventors: Talia T. Ho, Ann Arbor, MI (US); Earnee J. Gilling, Ypsilanti, MI (US); Tomohiro Matsukawa, Ann Arbor, MI (US)

(73) Assignee: Toyota Motor Engineering & Manufacturing North America, Inc., Erlanger, KY (US)

(21) Appl. No.: 15/265,074

(22) Filed: Sep. 14, 2016

(51) Int. Cl. G06F 3/0484; G06F 3/0481; G06F 3/0485; G06F 3/01; G06F 17/22

(52) U.S. Cl. CPC G06F 3/04847; G06F 3/04817; G06F 3/0485; B60R 16/027; G06F 3/04855; G06F 17/2241; G06F 3/016

(57) ABSTRACT

A vehicular human-machine interface, a dashboard and a method of providing information to a driver of a vehicle. The interface includes a multi-information display that provides a driver icons that are representative of a vehicle systems such that the driver can view, and if necessary, control through the interface. Input is simplified through a reduced set of directional buttons on a steering wheel-mounted four-way switch. By eliminating a separate BACK button from the steering wheel, driver input operations to achieve navigational control between various vehicle system menus that correspond to the icons, as well as sub-menus within a particular vehicle system, is simplified. The simplified navigation that is either between various icons on the display or various menu-based levels that can be sequentially shown also permits, in addition to viewing various vehicle system operational parameters, the ability to change such parameters through adjustment through the human-machine interface.

### TECHNICAL FIELD

The present specification relates generally to a method and system for controlling access to vehicle information and operation through a display and an input device mounted on a steering wheel, and more particularly the use of a simplified input device to improve user interaction with the display.

### BACKGROUND

Vehicle-mounted switches are commonly used to provide informational access to and control of one or more vehicular systems, including navigation, telecommunications, diagnostics, audio/video, vehicle monitoring, climate control, cruise control or the like. These switches—which along with their corresponding display make up a vehicular human-machine interface (HMI)—are often referred to as “hard” switches in that they provide a tactile interface between the driver and the underlying control software that provides the necessary signals to carry out the instructions commensurate with the switch's intended function. In one form, such hard switches are mounted onto one or more of the spokes that connect the center portion of the wheel to the peripheral rim. In this way, a driver holding the steering wheel can control a particular vehicular system through operation of the switches without having to remove his or her hands from the steering wheel.

These switches are typically coupled to a display unit that can be used to provide visual cues to the driver of information of the various vehicular systems that are available for access or manipulation. In this way, the display informs the driver of which vehicle system or function is presently being controlled by each switch. The display can be made to provide such information in menu-based formats in what is commonly referred to as a multi-information display (MID), where various system categories may be represented by screen-based icons or related graphical-user interfaces (GUIs). The driver may toggle the various buttons on the switch or switches in order to activate various menus within the MID, while subsequent toggling may be used to navigate sub-menus that present in more detail options associated with a particular menu or sub-menu choice.

One popular form of steering wheel-mounted switch is the four-way switch, which comprises a generally circular shape with one or more buttons situated around the periphery thereof to be responsive to driver input. In one form, these peripheral buttons may correspond to up, down, right and left directional arrows that correspond to an intended navigational direction that is represented on the two-dimensional MID such that once a desired icon within a particular menu or sub-menu is highlighted on the MID, the driver may depress an ENTER button (which in one form may be disposed generally in the center of the circular four-way switch) in order to initiate access to the vehicular system that corresponds to the highlighted choice. In another form, the four-way switch may be populated with dedicated (i.e., pre-set) menu selections rather than situation-dependent directional arrows.

Regardless of whether these switches are configured to have dedicated or situation-dependent functional attributes, a primary difficulty is associated with the use of one or more redundant set of these hard switches, as the driver may have to remember not only myriad switch manipulating steps, but also a correct order for implementing such steps, as well as when a particular use of such hard switch may not be permissible. This results in confusing and inefficient switch usage. This difficulty is exacerbated by recent trends in automotive passenger compartments in general and driver-oriented instrumentation cluster in particular to present an often overwhelming amount of information to the driver.

Accordingly, a need exists for improved HMI that simplifies both a driver's access to information being shown on the MID as well as control of vehicle systems that correspond to such displayed information.

### SUMMARY

In one embodiment, a vehicular HMI is disclosed. The HMI includes a MID, a steering wheel-mounted switch and a control unit such that upon receipt of a tactile input from a driver or other user of the HMI, various icons representative of a vehicular system may be selected. In addition, once a particular icon is selected, the user may toggle among hierarchical menus and sub-menus in order to gain visual access to and, if desired, change one or more operational parameters associated with the selected vehicular system. While the switch includes numerous directional buttons, as well as an optional ENTER or OK button, it does not include a separate (i.e., dedicated) BACK button, thereby simplifying the user's input options by reducing the number of buttons. Because the control unit is responsive to the back-and-forth toggling of the various directional buttons (which may include using the already-existing left arrow (i.e., left) directional button as the functional equivalent of a conventional dedicated BACK button), the navigation across the various icons is simplified, as is the navigation between one or more sub-menus and a main menu that corresponds to such icons.

In another embodiment, a vehicular dashboard includes a steering wheel and one or more instrument clusters. The steering wheel includes a switch mounted on the wheel's spoke, rim or central body portion. The switch includes numerous directional buttons that may be initiated by a tactile input from a driver. Significantly, the switch does not include a separate or dedicated BACK button. One of the instrument clusters is disposed adjacent the steering wheel such that the instrument cluster is readily be viewed by a driver that is situated in front of the steering wheel. This instrument cluster includes one or more gauges configured to provide visual indicia of an operational status of the vehicle. In addition, the instrument cluster includes an MID that provides visual indicia to the driver. Such indicia is in the form of icons that are each representative of a corresponding vehicle system. In this way, information about a particular vehicle system is selectively accessible for viewing as well as adjustment through additional tactile input by the driver through the switch. A control unit is signally coupled to the switch to selectively highlight one of the icons on the display.

In yet another embodiment, a method of providing vehicle system information on a multi-information display is disclosed. The method includes using the display to convey visual indicia in the form of icons, where each of the icons are representative of a corresponding vehicle system. The method additionally includes having a switch be placed in or on a steering wheel, where the switch includes numerous directional buttons that can receive tactile input from a driver. Significantly, the construction of the switch is simplified in that it does not include a separate BACK button. The switch and the display are signally cooperative with a control unit such that upon tactile input to the switch, the control unit instructs the display to selectively highlight one of the icons, while navigating between icons, as well as between various menus and sub-menus that are grouped under each icon, can be done solely through one or more of the directional buttons on the switch. In one particular form, when the driver or other user is desirous of ascending to a higher level within a menu or sub-menu, one of the directional buttons is used rather than a separate, dedicated BACK button.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a view of a driver's position in a vehicle passenger compartment showing steering wheel-mounted switches and an MID that may be used in accordance with one or more embodiments shown or described herein;

FIG. 2 depicts a view of a steering wheel that includes a switch according to the prior art;

FIG. 3 depicts a view of a steering wheel that includes a switch according to one or more embodiments shown or described herein;

FIG. 4 depicts a block diagram of a vehicular HMI according to one or more embodiments shown or described herein;

FIGS. 5A through 5C depict a sequence of MID screens that can be sequentially accessed through the switch of FIG. 3; and

FIG. 6 depicts a flowchart illustrating the cooperation between the MID and the steering wheel switch of FIG. 3.

### DETAILED DESCRIPTION

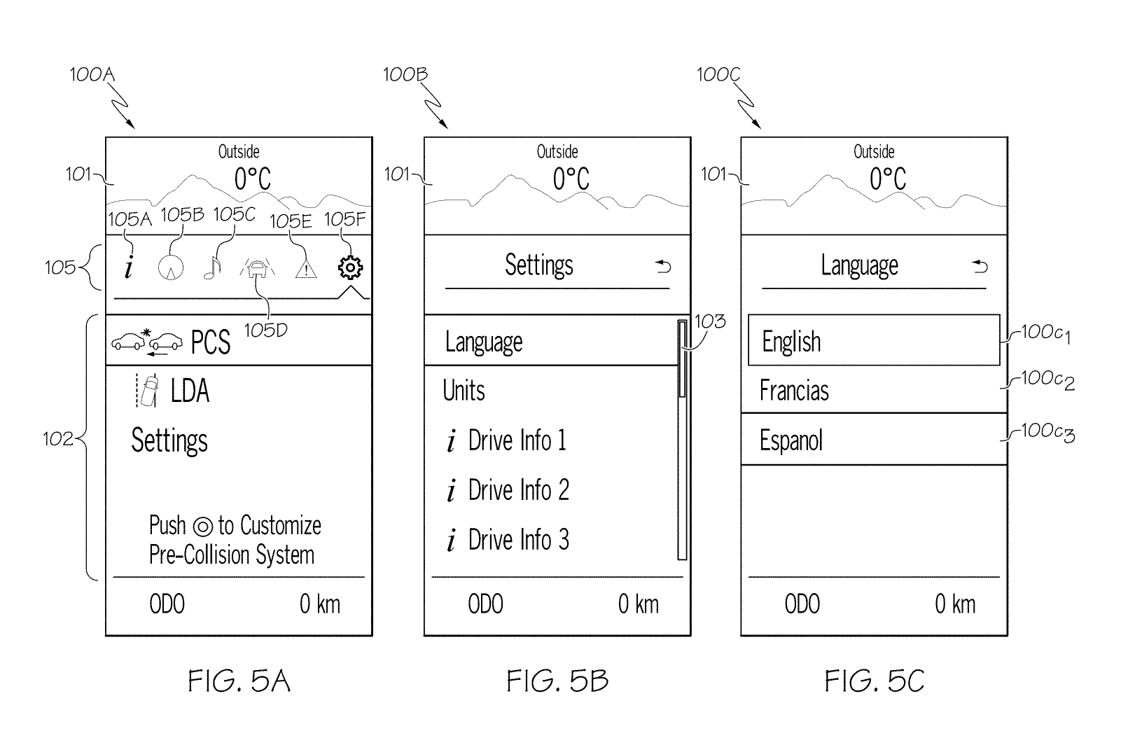

Embodiments disclosed herein include consolidating MID menu/sub-menu navigation operations through the use of a single hard switch (specifically, the 4-way switch) to gain access to numerous software-driven “soft switches” that are stored as part of user interface control logic on a control unit for corresponding display on the MID screen. An example of the use of these soft switches to navigate one particular vehicular system (specifically, the LANGUAGE menu within the SETTINGS icon) is shown below in FIGS. 5A through 5C.

Because they are software controlled, their underlying functions need not be tied to corresponding dedicated position on the hard switch. Unlike the conventional approach (which requires the use of a separate dedicated back button switch), the streamlined approach of the present invention uses existing buttons from the 4-way switch, thereby permitting the user to only have to familiarize himself or herself with a single switch that is populated with already-familiar directional arrows. Thus, going back to a previous (i.e., higher-level) menu—such as to the first screen of FIG. 5A from FIG. 5B, or to the second screen of FIG. 5B from the third screen of FIG. 5C, or the like—is made simple through depressing a single button on the switch (such as the left arrow that is situated at the 9 o'clock position of the 4-way switch). As such, movement between the screens of the MID can be dynamically controlled in a lateral or hierarchical fashion while simultaneously reducing the number of switches, thereby simplifying the HMI 400 (as discussed in more detail below). In the present context, a lateral movement is one that can be made between various icons, tabs or menu or sub-menu choices within a common level, whereas hierarchical movement is one that can be made between various screen levels.

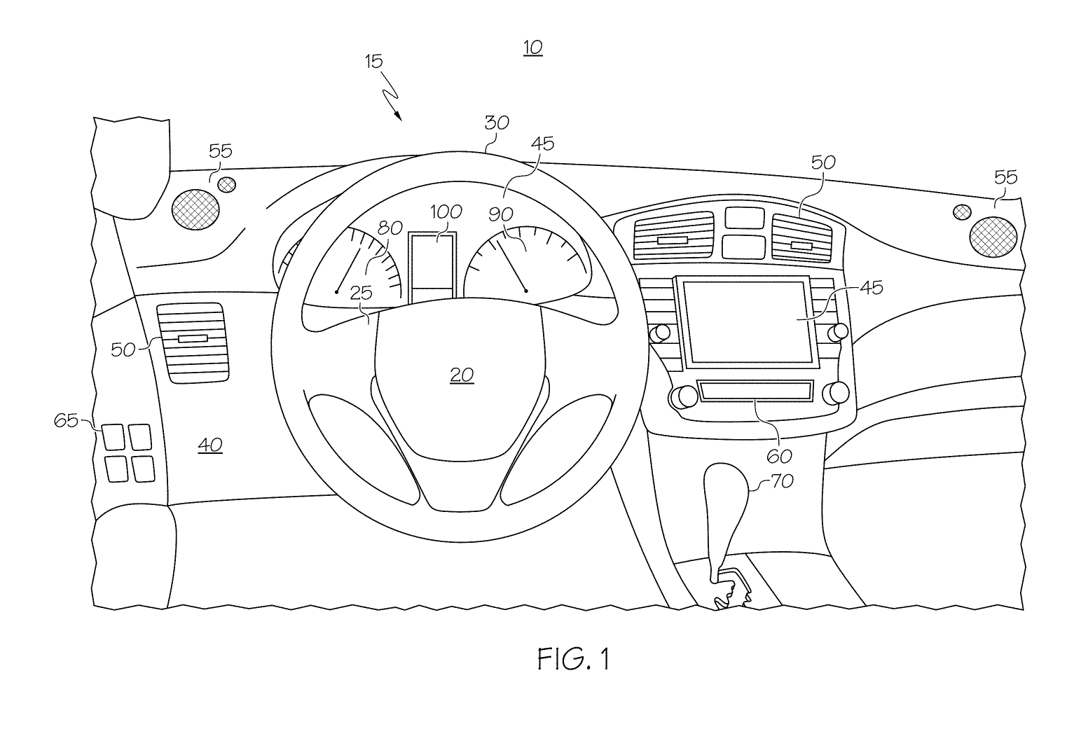

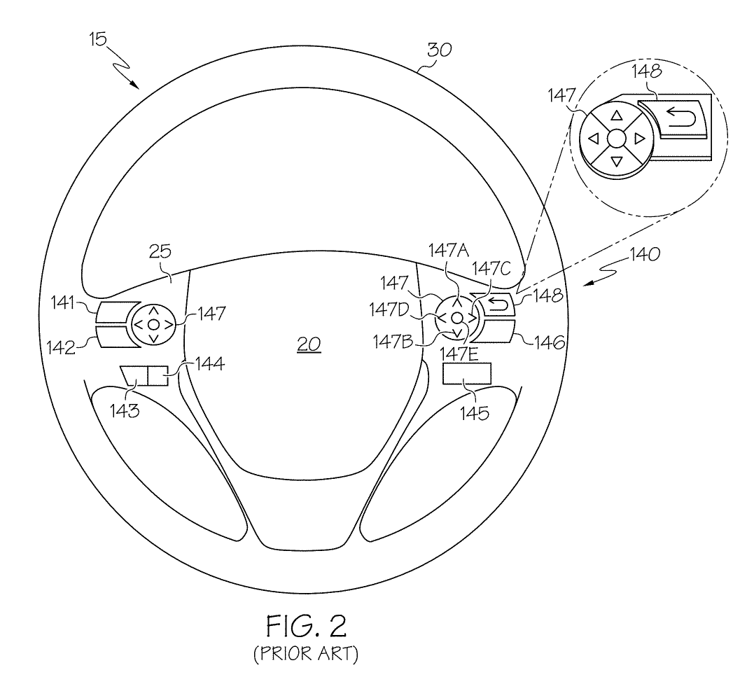

Referring first to FIGS. 1 and 2, the driver's portion of a vehicle passenger compartment 10 is shown. As will be understood by those skilled in the art, the portions depicted within the vehicle passenger compartment 10 that are applicable to both the prior art steering wheel 15 of FIG. 2 as well as the steering wheel 15′ of the present disclosure are set forth in order to provide context to the present disclosure. Accordingly, within such passenger compartment 10 are various components used to control operation of the vehicle, as well as provide information to the driver or passengers. In particular, an exemplary steering wheel 15 includes a central hub 20, various radial spokes 25 and a peripheral rim 30. As is commonly understood, the steering wheel 15 is designed to rotate about a steering axis in response to driver-initiated turning commands as a way to control the direction the vehicle.

As shown with particularity in FIG. 2, numerous switches 140 include various switches 141 through 146 that are conventionally configured as dedicated switches such that they have a singular, defined function that is invariant. Examples associated with such switches may include audio forward and backward buttons, telephone on/off buttons, cruise control increase/decrease speed buttons or the like. One of the four-way switches 147 (shown as the one on the right spoke 25 of wheel 15)—while possessive of directional arrows 147A through 147D and a central ENTER button 147E—is also part of a larger cluster that includes a separate but dedicated BACK button 148. Moreover, as shown in the detail of FIG. 2, the switch 147 is often formed integrally with the dedicated BACK button 148, resulting in a relatively large, complex assembly. When a user is attempting to perform a hierarchical scrolling operation through a variety of menus or sub-menus, it may take repeated actuating inputs through the BACK button 148 before the user arrives at a desired screen level.

Referring again to FIG. 1, in addition to the steering wheel 15, a dashboard 40 is situated within the passenger compartment 10 and is used to house various instrument clusters 45, heating, ventilation and air conditioning (HVAC) outlets 50, audio speakers 55, radio or related sound system 60, toggle switches 65, gear shifter or selector 70 and other driver or passenger interfaces that are commonly associated with vehicle operability. By way of example, one of the instrument clusters 45 can be centrally located within the passenger compartment 10 for use as a main display to provide a map, clock, compass, radio station list, as well as various other messages commonly associated with a vehicular telematics unit or related infotainment system. Another of the instrument clusters 45 is arranged to be substantially collinear with the turning axis of the steering wheel 15 so that it is particularly within the driver's field of view. This instrument cluster 45 includes various gauges, lights and associated indicators such as a speedometer 80, tachometer 90 for ease of view to the driver. Other gauges, such as fuel gauge, oil pressure gauge, oil temperature gauge, coolant temperature gauge or the like may also be included in this instrument cluster 45. More particularly, a MID 100 is disposed between the speedometer 80, tachometer 90 such that it is directly in front of the driver's eyes. In one form, the MID 100 is a thin-film transistor (TFT) form of the liquid crystal display (LCD).

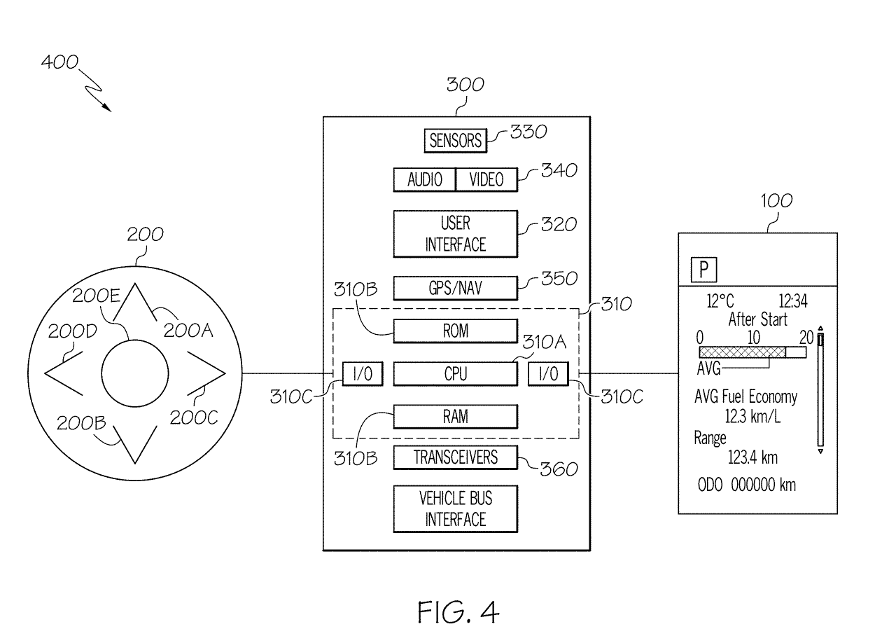

Referring next to FIG. 4, a schematic representation showing cooperation between a MID 100, input device 200 and control unit 300 according to one embodiment of the present disclosure is shown, where together, these three components define HMI 400 that allows simplified driver access to information and optional control for selective viewing and adjustment of one or more vehicular systems such as audio/video, navigation, climate control, maintenance, performance, safety systems or the like. In one form, HMI 400 resembles a computer connected to an input for receiving driver instructions such that an output of such instructions, as well as a status of the selected vehicular system, can be viewed by the driver, passenger or other occupant of the vehicle. The control unit 300 includes control logic (such as that stored in memory in the form of user interface software or the like) to permit the conveyance of such system information through numerous sequential and interactive menus and sub-menus. As will be understood, the hierarchical structure of the various menus and sub-menus is preferably based on levels of system specificity, where the level closest to the menu tends to present system information in a more general manner, while the levels that correspond to one or more layers of sub-menus tend to present system information in a more detailed manner.

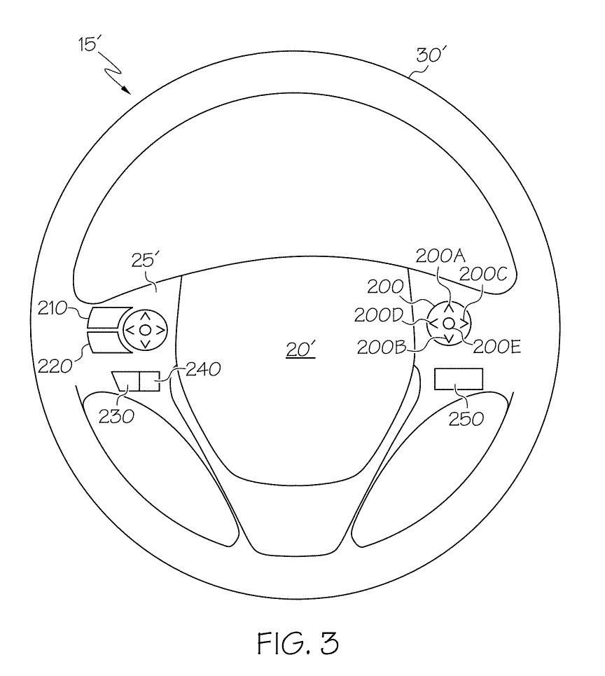

Referring next to FIG. 3 in conjunction with FIG. 1, a steering wheel 15′ according to an embodiment of the present disclosure is shown. Switch 200 acts as a manual input device that is responsive to tactile input from a driver (not shown), such as through a thumb or related digit. The switch 200 allows the driver to send commands to the control unit 300 for the purpose of changing the information data on MID 100. Thus, it can be used to navigate through multiple, sequential, interactive menu interfaces, as well as initiate vehicle system changes in response to tactile input from the driver. Switch 200 is preferably in the form of a four-way switch that is generally circular in nature and secured to a housing that can be affixed as a module to spoke 25′ of the steering wheel 15′. Although not shown, the module that contains switch 200 may be disposed in other locations of the steering wheel 15′, and all such variants are deemed to be within the scope of the present disclosure. In one form, the module may include mounting tabs or other suitable structures for securely affixing the switch 200 to the steering wheel 15′.

In one form, the switch 200 includes a central button 200E that operates like an ENTER or OK button and is used to allow the driver to make a selection that corresponds to a particular icon 105 (as will be discussed in more detail in FIGS. 5A through 5C below), menu or sub-menu to navigate MID 100, as well as to decide which icon, menu or sub-menu is being displayed at any given time. Various directional buttons 200A through 200D are placed peripherally around the central button 200E; these directional buttons 200A through 200D correspond generally to compass points north, south, east and east in order to create in the driver's mind a mental image of whether a particular tactile input is meant to selectively highlight (through for example a moving cursor, not shown) a suitable icon on the left, right or somewhere in-between on MID 100. Ergonomically, the directional buttons 200A through 200D can be arranged in generally equal radial and circumferential increments about axis defined by central button 200E, thus establishing four quadrants that correspond to familiar north, south, east and west compass or navigational points. By pressing down in a tilting manner in a mutually-independent manner on one of the buttons on switch 200, selective circuit contact is completed for electrical detection of the corresponding driver-initiated input signal. Although not shown, various forms of contacts may be established, including electrical contact-based, spring-based or capacitance-based. Regardless of the construction, a switch signal generated by the steering wheel switch 200 is sent to the control unit 300 for processing and consequent instructions to MID 100.

Importantly, by the present construction of switch 200, the removal of redundant hard switches (such as a dedicated back button 148) reduces layout complexity and therefore helps promote simpler HMI 400 operation. In another form, the newly-created empty space above switch 200 could be filled with something else that may be more useful, such as relocating the trip odometer button (not shown) that is usually located adjacent the speedometer 80 or tachometer 90 of FIG. 1 to the location where the (now superfluous) hard BACK button formerly resided. In yet another form, such a trip odometer button could also be relocated as button 250. Furthermore, it improves overall HMI 400 layout by reducing the amount of support circuitry required. By having the directional buttons 200A, 200B, 200C and 200D of switch 200 be assigned generic functions, the switch can be made to interact with the control unit 300 and MID 200 in dynamic, situation-dependent ways that dedicated switches (with their attendant one-to-one correspondence) cannot. This in turn allows for more design flexibility in the control logic, which in turn reduces the number of switches populating the spokes, rim or other surfaces of steering wheel 15′.

Referring next to FIGS. 5A through 5C in conjunction with FIG. 3, the sequential images shown therein correspond to varying hierarchical levels associated with an icon 105 on a highest-level (i.e., default) screen 100A (FIG. 5A), a single menu item 100B (SETTINGS) showing one of its selectively-displayable vehicle system categories (LANGUAGE) along a scrollable screen within a particular icon 105F (FIG. 5B) and a sub-menu 100C associated with the chosen vehicle system category and various selectable options 100C₁, 100C₂ and 100C₃ (FIG. 5C) that may correspond to one or more adjustable vehicle system operational parameters. Other indicia, such as ambient external temperature and background theme (shown presently as a mountain range) may be shown in a portion 101 of each of the screens 100A through 100C, while another portion 102 may be used to display the most recently-accessed menu or sub-menu item when in the highest-level screen 100A, as well as the present list of options presently-available when in the individual menu screen 100B or one of the sub-menu screens 100C. As is also shown with particularity in individual menu screen 100B, the scrollable nature of any given list is depicted by the scroll bar 103 on the right side. Once highlighted, the up and down arrows 200A, 200B on switch 200 may be used to navigate using the scroll bar 103 feature.

The screens 100A through 100C offer a basic representation of the proposed MID 100, as well as access to and navigation between the various menus and sub-menus that correlate to the various icons 105 of the top-level screen 100A. In particular, the MID 100 screen is always in an “on” position when the vehicle is operating. As can be seen in the top-level screen 100A of FIG. 5A, the icons 105 correspond to six different menu tabs displayed from left to right across the top of the screen. In the embodiment depicted, the icons 105 represent driver information 105A (which may include a menu, by way of example, that provides information about fuel consumption or the like), compass 105B (which may include a menu, by way of example, that provides maps, route guidance or related navigational information), audio (or audio/video) system 105C (which may include a menu, by way of example, that provides information pertaining to radio stations, multimedia inputs, CDs, DVDs or other on-board audio/video file storage, as well as external devices that contain audio or video files), driver assist 105D (which may include a menu, by way of example, that provides lane departure, dynamic radar cruise control or pre-collision warning information), vehicle system warnings 105E (which may include a menu, by way of example, that provides diagnostic information pertaining to one or more vehicular systems in response to sensor-acquired data) and settings 105F (which may include a menu, by way of example, that provides climate control, language, time/date, steering control, parking assist, blind-spot warning or other customizable information). It will be understood that the various menus that are subsumed under the various icons 105A through 105F are preferably provided for sequential display on MID 100 in a hierarchical structure. In this way, more general (i.e., top-level) information about a selected vehicle system or function appears on the screen of FIG. 5A that shows the icons 105A through 105F in a manner that itself may be considered a main menu, while one or more menus from screen 100B under each icon 105 as well as sub-menus from screen 100C under each menu preferably provides increasing levels of detail associated with such system or function. It will be appreciated that the number of icons 105 presently depicted is by way of example rather than limitation, and that greater or fewer number may be displayed, depending on the needs of the vehicle.

As mentioned above, MID 100 screen is always in an “on” position when the vehicle is operating. Thus, if a user is interested in viewing a particular menu (or sub-menu), he or she merely presses the right-arrow button 200C that is situated at the 3 o'clock position of the 4-way switch 200 or left-arrow button 200D that is situated at the 9 o'clock position of the 4-way switch 200 (the choice of such left or right direction being contingent upon where the cursor that corresponds to a particular one of the icons 105A through 105D is situated when an attempted navigation is begun) and continues to scroll across the icons 105 until arriving at the particular icon (presently shown as SETTINGS icon 105F) of interest. For example, if the user wants to change settings, he or she scrolls to the rightmost tab through continuous or repeated sequential pressing of the right-arrow button until the SETTINGS tab is highlighted. By depressing the center button (typically labeled in exemplary fashion as OK on the 4-way switch), the SETTINGS menu of FIG. 5B is activated. From here, the user may depress the down arrow button 200D at the 6 o'clock position of the 4-way switch until the cursor arrives at the suitable tab this case, the LANGUAGE tab). Once the LANGUAGE tab is highlighted as shown in FIG. 5B, the user may move to a sub-menu (FIG. 5C) that permits the user to select from various language options 100C₁, 100C₂ or 100C₃, again by merely depressing the OK button 200E at the center of the four-way switch.

Thus, HMI 400 can promote reduced-button hierarchical change within a particular menu such as that depicted in FIG. 5B that corresponds to one of the selectively highlighted icons 105A through 105F of FIG. 5A. In one form such reduced-button hierarchical change is achieved exclusively through the tactile input from one of the plurality of directional buttons 200A, 200B, 200C or 200D. More particularly, hierarchical ascendancy from a lower sub-menu may be achieved exclusively through the left arrow directional button 200D such that a separate hard switch BACK button is rendered superfluous. Likewise, hierarchical ascendancy from a sub-menu to a menu—as well as from a menu of FIG. 5B to the top-level screen of FIG. 5A—may be achieved exclusively through the left arrow directional button 200D. This use of the left-arrow button 200D as a surrogate for a hard BACK button is consistent with and permissible by the control logic within control unit 300 because at the menu level and sub-menu level, there are no other left and right movement options as the screen is within the realm of a single choice in control movement. In other words, at these lower (i.e., non-top) screen levels, there are no permissible lateral movements, meaning that engagement of the left-arrow button 200D can only unambiguously be construed to ascend to the next-higher screen level). Contrarily, lateral changes between the icons 105A through 105F of the top-level screen of FIG. 5A are achieved exclusively through the tactile input from either the right or left directional buttons 200C, 200D as before.

Importantly, navigating between various menus and sub-menus within the MID 100 of such information is simplified based on the provided signal solely on driver tactile engagement with one of the directional choices on an input device in the form of switch 200. Within the present context, this sole engagement based on driver input via the directional choices that correspond in general to switch buttons 200A, 200B, 200C or 200D and in particular to the left-arrow switch 200D that performs the functional equivalent of a hard BACK switch without the need for separate hardware means that such a dedicated BACK button is not needed. This reduced number of switches and their associated buttons means that such a hierarchical toggling button, along with its inefficiently-used single function of moving between various levels, is eliminated. As such, the navigation between various screens such as 100A through 100C and their differing levels only requires engagement of one of the four directional arrows on simplified switch 200. The reduced instruction set associated with using switch 200 intuitively follows a ‘left-arrow-equals-backward” protocol; because this is achieved without the need for a separate BACK button, the HMI 400 and associated method reduces driver mental workload in that such that redundant hierarchical toggling between various levels within a category, as well as between categories, is eliminated. Moreover, this reduction in driver workload will experience a multiplicative effect as the number of vehicular systems that can be controlled through HMI 400 increases.

Although the number of screen levels is shown at three in FIGS. 5A through 5C, it will be appreciated that larger or smaller numbers of such screens may be used, depending on the need. In particular, it is envisioned that as the number of vehicular systems and their parameters that can be monitored and controlled increases, the number of sub-menus subsumed under the sub-menu screen 100C can be increased to accommodate such additional workload, and that such greater or fewer number of additional levels is within the scope of the present disclosure. Likewise, within the present context, the ascending or descending levels associated with the top-level, menu and sub-menu screens 100A, 100B and 100C of FIGS. 5A through 5C, simplify the task of displaying the corresponding vehicular system information within a sequential, interactive series of images to the driver in along with readily-available cursor-based indicia to simplify the driver's visual and mental workload.

In one form, the control unit 300 is configured to operate as a computer or related electronic control unit (ECU) such that it forms the central component through which most or all of the components of the HMI 400 interact. In one such form, control unit 300 may be configured with well-known von Neumann computer system architecture attributes to enable it to perform one or more specific automated steps outlined in this disclosure. For example, control unit 300 preferably includes a computer 310 made up of processor 310A, memory 310B and input and output 310C. These various components are presently depicted as being signally-coupled function blocks that are shown separately for illustration purposes, although it will be appreciated that these blocks may also be structurally configured to define one or more components in or around the processor 310A such that they are a part of the internal functioning of the processor 310A itself. For example, in one form, the control unit 300 may be constructed as a microcontroller where the processor 310A, memory 310B, input and output 310C are integrally formed on a single chip. With the inclusion of appropriate logic such as that contained as part of the user interface 320 (which may or may not be stored in memory 310B, depending on the way the logic is structured), the control unit 300 may be programmed to provide various control functions as is known in the art. In one form, memory 310B for the storage of software and gathered data may include static memory such as read-only memory (ROM) and dynamic memory such as random access memory (RAM) and their variants. As such, the use of the control unit 300 in the manner set forth herein permits it to become a particularly-adapted computer or computer-related data processing device for performing at least some of the HMI 400 control discussed herein. It will be appreciated by those skilled in the art that computer-executable instructions that embody operations discussed elsewhere in this disclosure can be placed within an appropriate location (such as the aforementioned memory 310B) within control unit 300 in order to achieve the objectives set forth in the present disclosure.

Additional components are also placed in cooperation with the computer 310 in order to facilitate operation of control unit 300; these may include sensors 330, audio/video files 340, GPS/navigational equipment 350, one or more transceivers 360 to facilitate wireless communication between the vehicle and external telecommunications infrastructure, and a bus interface 370 to establish wiring or related signal communication within a controller area network (CAN, not shown) bus. By the appropriate choice of cursor movement algorithms such as those known to those skilled in the art, control unit 300 may through processor-based operation on those algorithms control a movement of the cursor on MID 100 in response to the signals that are output from the switch 200. In one form, such algorithms may be stored in memory, either as control logic, or as part of a lookup table.

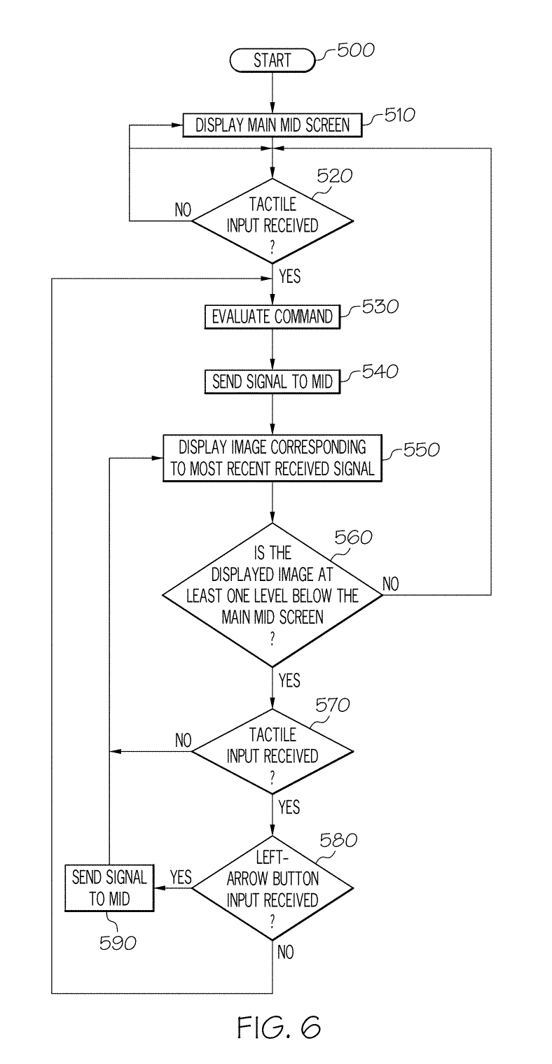

Referring next to FIG. 6 in conjunction with FIGS. 5A through 5C, an example use of HMI 400 is shown. Upon startup of the vehicle, the control unit 300 initiates startup of the MID 100 at step 500, the control logic embedded within the control unit 300 sends a signal at step 510 to have MID 100 illuminate the screen that corresponds to the default screen state. As shown in FIG. 5A, such a screen 100A corresponds to the default settings associated with icons 105. At step 520, the logic ascertains whether one of the buttons 200A, 200B, 200C or 200D of switch 200 has been activated by the driver. In the event no such command has been received, the logic returns to step 510 to display the existing screen on MID 100, as well as wait on further instructions. Contrarily, if a command is received, then at step 530 the nature of the received command or input is evaluated, after which at step 540 a signal is sent to MID 100 that corresponds with the desired logic signal, while step 550 includes having the MID 100 display the image on the screen that corresponds to the signal being sent by the control logic from step 540, or if no new signal is sent, to display the present image until such time as a new signal is received. By way of non-limiting example, the image that is shown on screen 100B is that of the LANGUAGE menu under the SETTINGS icon 105F of screen 100A, while the image on screen 100C depicts various sub-menu selections under the LANGUAGE menu. At step 560, the logic ascertains whether the displayed image corresponds to a screen level that is at least one level below that of the main screen 100A, and if not, to return the control back to just prior to step 520 to await further tactile input from switch 200. Contrarily, if the control logic determines that the image being displayed corresponds to a menu-level or sub-menu-level screen (such as 100B or 100C as shown), then at step 570 the logic ascertains whether the user is desirous of returning to a previous screen; in this regard, this step is functionally similar to step 520 in that it is waiting for driver input via one of the buttons 200A, 200B, 200C or 200D on switch 200. In situations where no input is received, the logic defaults to a holding pattern associated with step 550 that continues to show the existing screen. If input from switch 200 is received, then the logic proceeds to step 580 to determine if left-arrow button 200D was activated. As discussed throughout this disclosure, the control logic is such that left-arrow button 200D can act as a surrogate for a hard BACK button in situations where the MID 100 has descended from the general level of detail in the default screen (such as screen 100A) to a more particular level of detail that is more closely associated with adjusting one or more vehicle system parameters. Thus, in one particular form (specifically, that of ascending to a higher-level screen within the display hierarchy), the specific input sought is that of the left-arrow button 200D that indicates a desire on the part of the driver to return to a previous screen. If so, then control passes to step 590, where the control unit 300 sends a signal back to step 550 to instruct the MID 100 to show the next higher-level screen in the sub-menu/menu/default screen cascade.

In an alternative version (not shown), instead of displaying the default screen 100A upon vehicle startup, the control unit 300 may instruct the MID 100 to display the last image before the vehicle was turned off. Either variant is deemed to be within the scope of the present disclosure.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicular human-machine interface comprising:
a multi-information display situated in a position to be viewed by a driver of a vehicle, the display configured to provide visual indicia in the form of icons presented thereon each of which are representative of a corresponding vehicle system that is selectively accessible for at least one of viewing and control by the driver;
a steering wheel-mounted switch that comprises a plurality of directional buttons that may be initiated by a tactile input from the driver, the switch not comprising a separate BACK button; and
a control unit cooperative with the switch to selectively highlight one of the icons on the display in response to a tactile input from the switch.

2. The interface of claim 1, wherein the switch comprises a four-way switch such that each of the directional buttons corresponds to a respective up, down, left or right instruction movement.

3. The interface of claim 2, wherein a hierarchical change within a particular menu that corresponds to the selectively highlighted one of the icons is achieved exclusively through the tactile input from one of the plurality of directional buttons.

4. The interface of claim 3, wherein hierarchical ascendancy between particular sub-menus that are grouped within the menu is achieved exclusively through the left directional button.

5. The interface of claim 2, wherein a lateral change between the icons is achieved exclusively through the tactile input from one of the plurality of directional buttons.

6. The interface of claim 1, wherein a hierarchical change within a particular menu that corresponds to the selectively highlighted one of the icons is achieved exclusively through the tactile input from one of the plurality of directional buttons.

7. The interface of claim 1, wherein a lateral change between the icons is achieved exclusively through the tactile input from one of the plurality of directional buttons.

8. A vehicular dashboard comprising:
a steering wheel projecting therefrom, the steering wheel comprising a wheel-mounted switch disposed thereon, the switch comprising a plurality of directional buttons that may be initiated by a tactile input from the driver, the switch not comprising a separate BACK button;
at least one instrument cluster disposed adjacent the steering wheel such that the instrument cluster is situated in a position to be viewed by a driver that is situated in front of the steering wheel, the instrument cluster comprising:
at least one gauge configured to provide visual indicia of an operational status of the vehicle; and
a multi-information display situated in a position to be viewed by the driver, the display configured to provide visual indicia in the form of icons presented thereon each of which are representative of a corresponding vehicle system that is selectively accessible for at least one of viewing and control by the driver; and
a control unit cooperative with the switch to selectively highlight one of the icons on the display in response to a tactile input from the switch.

9. The dashboard of claim 8, wherein the display is situated within the instrument cluster that is mounted along the axis of the steering wheel.

10. The dashboard of claim 8, wherein the switch comprises a four-way switch such that each of the directional buttons corresponds to a respective up, down, left or right instruction movement.

11. The dashboard of claim 10, wherein a hierarchical change within a particular menu that corresponds to the selectively highlighted one of the icons is achieved exclusively through the tactile input from one of the plurality of directional buttons.

12. The dashboard of claim 11, wherein hierarchical ascendancy between particular sub-menus that are grouped within the menu is achieved exclusively through the left directional button.

13. The dashboard of claim 10, wherein a lateral change between the icons is achieved exclusively through the tactile input from one of the plurality of directional buttons.

14. The dashboard of claim 8, wherein a hierarchical change within a particular menu that corresponds to the selectively highlighted one of the icons is achieved exclusively through the tactile input from one of the plurality of directional buttons.

15. The dashboard of claim 8, wherein a lateral change between the icons is achieved exclusively through the tactile input from one of the plurality of directional buttons.

16. A method of providing vehicle system information on a multi-information display, the method comprising:
conveying, on the display, visual indicia in the form of icons each of which are representative of a corresponding vehicle system;
disposing a switch on a steering wheel that is used to provide directional control of the vehicle, the switch comprising a plurality of directional buttons, the switch not comprising a separate BACK button; and
configuring a control unit to cooperative with the switch and the display such that upon tactile input to the switch, the control unit instructs the display to selectively highlight one of the icons thereon.

17. The method of claim 16, wherein the switch is a four-way switch such that a hierarchical change within a particular menu that corresponds to the selectively highlighted one of the icons is achieved exclusively through the tactile input from one of the plurality of directional buttons.

18. The method of claim 17, wherein hierarchical ascendancy between particular sub-menus that are grouped within the menu is achieved exclusively through the left directional button.

19. The method of claim 17, wherein a lateral change between the icons is achieved exclusively through the tactile input from one of the plurality of directional buttons.

20. The method of claim 16, further comprising adjusting at least one operational parameter within the corresponding vehicle system.
